(19) United States
(12) Patent Application Publication
(10) Pub. No.: US 2017/0152438 A1
(43) Pub. Date: Jun. 1, 2017

(54) CLUSTERED NANOCRYSTAL NETWORKS AND NANOCRYSTAL COMPOSITES

(71) Applicants: Henkel IP & Holding GmbH, Duesseldorf (DE); Henkel AG & Co. KGaA, Duesseldorf (DE)

(72) Inventors: Elisabet Torres Cano, Barcelona (ES); Fouad Salhi, Barcelona (ES); Jozeph Leendert Minnaar, Zeeland (NL); Albert Almarza Martinez, Barcelona (ES); Mireia Morell Bel, Salt (ES); Camille Marie, Cabourg (ES); Paz Carreras, Barcelona (ES)

(21) Appl. No.: 15/429,932

(22) Filed: Feb. 10, 2017

Related U.S. Application Data
(63) Continuation of application No. PCT/EP2015/068233, filed on Aug. 7, 2015.

(30) Foreign Application Priority Data
Aug. 11, 2014 (EP) 14180538.2

(51) Int. Cl. C09K 11/88; C09K 11/62; C09K 11/02

(52) U.S. Cl. CPC C09K 11/883; C09K 11/025; C09K 11/881; C09K 11/623; B82Y 40/00

(57) ABSTRACT

The present invention relates to a clustered nanocrystal network comprising a core comprising a metal or a semiconductive compound or mixture thereof and at least one polythiol ligand, wherein said core is surrounded by at least one polythiol ligand, and wherein each core surrounded by at least one polythiol ligand is crosslinked with at least one another polythiol ligand stabilizing another core. Furthermore, the present invention relates to nanocrystal composites comprising clustered nanocrystal networks. Clustered nanocrystal networks according to the present invention can be prepared by one-pot synthesis and can be embedded into the polymer matrix to form high quality and stable nanocrystal composites.

### TECHNICAL FIELD

The present invention relates to a clustered nanocrystal network comprising a plurality of nanocrystals comprising a core comprising a metal or a semiconductive compound or a mixture thereof and at least one polythiol ligand, wherein said core is surrounded by at least one polythiol ligand, and wherein each core surrounded by at least one polythiol ligand is crosslinked with at least one another polythiol ligand surrounding another core. Furthermore, the present invention relates to nanocrystal composites comprising clustered nanocrystal networks. Clustered nanocrystal networks according to the present invention can be prepared in one-pot synthesis, and can be embedded into the polymer matrix to form nanocrystal composites.

### BACKGROUND OF THE INVENTION

Nanocrystals (NCs) when exposed to air and moisture undergo oxidative degradation, often resulting in a loss of photoluminescence quantum yield (PL-QY). The incorporation of NCs into solid matrices from their grown solution has been the most established strategy to try to prevent or at least diminish the loss of properties. However, the use of encapsulated NCs in solid state applications, such as light down-conversion, often expose NCs to elevated temperatures, high intensity light, environmental gasses and moisture. All these factors limit the luminescent lifetime and frequent replacement is normally required.

One recent method in the prior art is based on the double encapsulation of NCs. This method consists of three main steps. The first step is based on the physical mixing of nanocrystal (NC) solutions with a polymer solution or a crosslinking formulation to obtain a first NC-composite. Subsequently, in the second step the obtained NC-composite is grinded into a 50 μm powder. The third step consists of mixing the powder into another polymer solution or a crosslinking formulations to obtain the final NC-composite. In this case, the double NCs encapsulation is used to add an additional protective barrier over the NCs. In this approach the diffusion pathway of small molecules (e.g. O₂, water) throughout the NC-composite is complex. However, this method suffers from three main disadvantages. Firstly, the overall process requires a minimum of 5 steps. This can have an effect on the production and reproducibility of the material. The second disadvantage is that the method involves a ligand exchange step before the preparation of the first NC-composite. This step is conducted to improve the compatibility of the NCs with the polymer solution or a crosslinking formulation. However, it leads to an increase in defects on the surface of the NCs, which have a negative effect on the final properties e.g. photoluminescence (PL) and electroluminescence (EL). The last disadvantage is that physico-chemical incompatibilities can arise between NCs and polymer solution or a crosslinking formulation during the first NC-composite preparation. These incompatibilities are known to worsen the initial luminescent properties of the NCs.

Therefore, there is a need for improved double NC encapsulation methods and compositions to not only protecting NCs against oxidation but also towards simplified procedures capable to preserve the initial and unique properties of the NCs.

### SHORT DESCRIPTION OF THE FIGURES

FIG. 1 illustrates the structure of the network formed by crosslinked nanocrystals according to the present invention.

FIG. 2 illustrates the structure of the NC-composite according to the present invention.

### SUMMARY OF THE INVENTION

The present invention relates to a clustered nanocrystal network comprising a plurality of nanocrystals comprising a core comprising a metal or a semiconductive compound or a mixture thereof and at least one polythiol ligand, wherein said core is surrounded by at least one polythiol ligand, and wherein each core surrounded by at least one polythiol ligand is crosslinked with at least one another polythiol ligand surrounding another core.

In addition, the present invention relates to a process to prepare solid clustered nanocrystal networks according to the present invention.

The present invention also encompasses a nanocrystal composite comprising clustered nanocrystal networks according to the present invention and a polymer matrix, wherein said clustered nanocrystal networks are embedded into said polymer matrix.

In addition, the present invention relates to a process to prepare nanocrystal composite comprising clustered nanocrystal networks according to the present invention.

Furthermore, the present invention encompasses a product comprising a nanocrystal composite comprising clustered nanocrystal networks according to the present invention, wherein said product is selected from the group consisting of a display device, a light emitting device, a photovoltaic cell, a photodetector, an energy converter device, a laser, a sensor, a thermoelectric device, a security ink and in catalytic or biomedical applications.

Finally, the present invention encompasses, use of nanocrystal composites according to the present invention as a source of photoluminescence or electroluminescence.

### DETAILED DESCRIPTION OF THE INVENTION

In the following passages the present invention is described in more detail. Each aspect so described may be combined with any other aspect or aspects unless clearly indicated to the contrary. In particular, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps.

The recitation of numerical end points includes all numbers and fractions subsumed within the respective ranges, as well as the recited end points.

All percentages, parts, proportions and the like mentioned herein are based on weight unless otherwise indicated.

When an amount, a concentration or other values or parameters is/are expressed in form of a range, a preferable range, or a preferable upper limit value and a preferable lower limit value, it should be understood as that any ranges obtained by combining any upper limit or preferable value with any lower limit or preferable value are specifically disclosed, without considering whether the obtained ranges are clearly mentioned in the context.

All references cited in the present specification are hereby incorporated by reference in their entirety.

Unless otherwise defined, all terms used in the disclosing the invention, including technical and scientific terms, have the meaning as commonly understood by one of the ordinary skill in the art to which this invention belongs to. By means of further guidance, term definitions are included to better appreciate the teaching of the present invention.

The present invention relates to the clustered nanocrystal networks and the preparation of them. Furthermore, the present invention relates to the NC-composites comprising clustered nanocrystal networks and to the preparation of NC-composites.

Benefits of the present invention over the technology disclosed in the prior art are 1) double encapsulation of the NCs, which can prevent NC degradation which means NCs are crosslinked with themselves and then encapsulated into polymer matrix; 2) there is no loss in optical properties by the formation of clustered nanocrystals network that is explained by the crosslinking of ligands, which help maintaining a constant distance between NCs; 3) no aggregation will occur inside the final material with the clustered nanocrystal networks according to the present invention, even when high loadings are used; 4) there is no need to use photoinitiators in the formation of clustered nanocrystal networks; 5) approach according to the present invention enables safe handling of the NCs since nanopowders are encapsulated into bulk; and 6) simplified production procedure is created by avoiding ligand exchange step.

Clustered NCs networks are useful for a wide range of encapsulants for example thermoplastics, thermosets, organic or inorganics oxides.

By the term ‘nanocrystal’ is meant a nanometer-scale crystalline particle, which can comprise a core/shell structure and wherein a core comprises a first material and a shell comprises a second material, and wherein the shell is disposed over at least a portion of a surface of the core.

By the term ‘ligand’ is meant molecules having one or more chains that are used to stabilize nanocrystals. Ligands have at least one focal point where it binds to the nanocrystal, and at least one active site that either interacts with the surrounding environment, crosslinks with other active sites or both.

By the term ‘clustered nanocrystal network’ is meant a solid system of colloidal nanocrystals crosslinked with their own reactive ligands that can be transformed into bulk particles.

The NCs described in the present invention do not undergo a ligand exchange process, which has been widely used in the prior art. Therefore, only the original ligands present during the synthesis are attached to the NCs. In contrast, NCs that undergo a ligand exchange process, have at least two type of ligands, the ligand attached during the synthesis and the ligand added during the ligand exchange. Studies have shown that after a ligand exchange process, part of the original ligand is still attached to the NC surface, see for example the paper of Knittel et.al. (Knittel, F. et al. On the Characterization of the Surface Chemistry of Quantum Dots. Nano Lett. 13, 5075-5078 (2013)).

Each of the essential components of the clustered nanocrystal network and the nanocrystal composite comprising clustered nanocrystal networks according to the present invention are described in details below.

### Clustered Nanocrystal Network

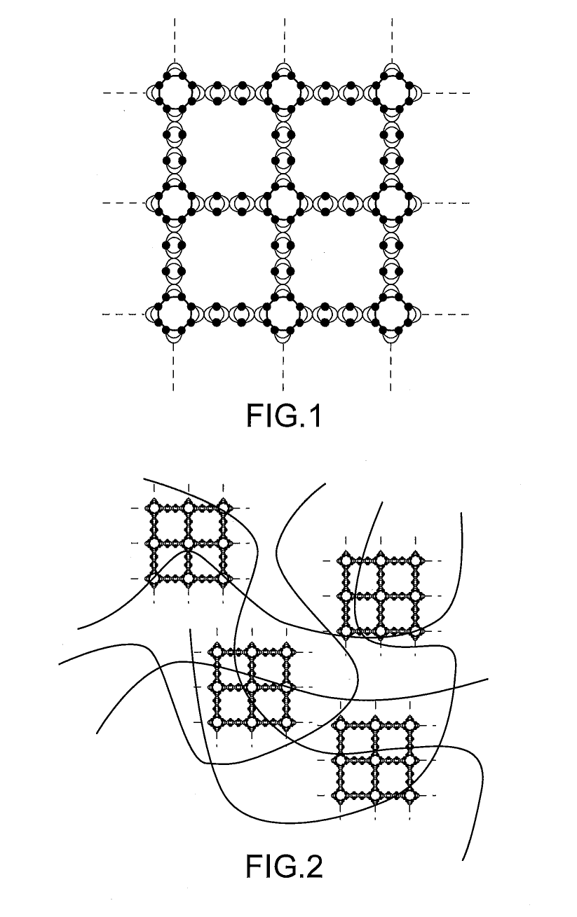

The present invention provides a clustered nanocrystal network comprising a plurality of nanocrystals comprising a core comprising a metal or a semiconductive compound or mixture thereof and at least one polythiol ligand, wherein said core is surrounded by at least one polythiol ligand, and wherein each core surrounded by at least one polythiol ligand is crosslinked with at least one another polythiol ligand surrounding another core. FIG. 1 illustrates this clustered nanocrystal network structure.

Preferably, a clustered nanocrystal network according to present invention is formed by covalently crosslinked NCs.

NCs forming the clustered NC network according to the present invention comprise a core comprising a metal or a semiconductive compound or mixture thereof and at least one polythiol ligand.

### Core Comprising a Metal or a Semiconductive Compound

Core of the nanocrystals according to present invention comprises metal or semiconductive compound or mixture thereof. A metal or a semiconductive compound is composed of elements selected from one or more different groups of the periodic table.

Preferably, the metal or the semiconductive compound is combination of one or more elements selected from the group IV; one or more elements selected from the groups II and VI; one or more elements selected from the groups III and V; one or more elements selected from the groups IV and VI; one or more elements selected from the groups I and III and VI; or a combination thereof. Preferably said metal or semiconductive compound is combination of one or more elements selected from the groups I and III and VI. More preferably said metal or semiconductive compound is combination of one or more of Zn, In, Cu, S and Se.

Optionally the core comprising the metal or the semiconductive compound may further comprise a dopant. Suitable examples of dopants to be used in the present invention are selected from the group consisting of Mn, Ag, Zn, Eu, S, P, Cu, Ce, Tb, Au, Pb, Sb, Sn, TI and mixtures thereof.

In another preferred embodiment the core comprising a metal or a semiconductive compound or a mixture thereof is core comprising copper in combination with one or more compound selected from the group I and/or group II and/or group III and/or group IV and/or group V and/or group VI.

In another preferred embodiment core comprising copper is selected from the group consisting of CuInS, CuInSeS, CuZnInSeS, CuZnInS, Cu:ZnInS, CuInS/ZnS, Cu:ZnInS/ZnS, CuInSeS/ZnS, preferably selected from the group consisting of CuInS/ZnS, CuInSeS/ZnS, Cu:ZnInS/ZnS.

The core of the nanocrystals according to the present invention has a structure including the core alone or the core and one or more shell(s) surrounding the core. Each shell may have structure comprising one or more layers, meaning that each shell may have monolayer or multilayer structure. Each layer may have a single composition or an alloy or concentration gradient.

In one embodiment, the core of the nanocrystal according to the present invention has a structure comprising a core and at least one monolayer or multilayer shell. Yet, in another embodiment, the core of the nanocrystal according to the present invention has a structure comprising a core and at least two monolayer and/or multilayer shells.

In one embodiment, the core of the nanocrystal according to the present invention has a structure comprising a core comprising copper and at least one monolayer or multilayer shell. Yet, in another embodiment, the core of the nanocrystal according to the present invention has a structure comprising a core comprising copper and at least two monolayer and/or multilayer shells.

Preferably, the size of the core of the nanocrystals according to the present invention is less than 100 nm, more preferably less than 50, more preferably less than 10, however, preferably the core is larger than 1 nm.

Preferably the shape of the core of the nanocrystal according to the present invention is spherical, rod or triangle shape.

### Polythiol Ligand

The individual nanocrystals forming the clustered nanocrystal network according to present invention comprise at least one polythiol ligand.

By the term polythiol is meant herein ligands having multiple thiol groups in the molecular structure. Furthermore, said polythiols used in the present invention have multiple functions (to act as a precursor, solvent and stabilizer), and therefore, can be considered as multifunctional polythiols. In other words the polythiol ligands used in the present invention are used as multifunctional reagents.

A polythiol ligand suitable to be used in the present invention has functionality from 2 or more, preferably from 3 to 4. Meaning that the polythiol ligand has at least 2 thiol groups in the structure, preferably from 3 to 4.

Suitable polythiol ligands to be used in the present invention is selected from the group consisting of primary polythiols, secondary polythiols and mixtures thereof. Preferably, at least one polythiol ligand is selected from the group consisting of pentaerythritol tetrakis (3-mercaptobutylate), pentaerythritol tetra-3-mercaptopropionate, trimethylolpropane tri(3-mercaptopropionate), tris[2-(3-mercaptopropionyloxy)ethyl]isocyanurate, dipentaerythritol hexakis(3-mercaptopropionate), ethoxilated-trimethylolpropan tri-3-mercaptopropionate, mercapto functional methylalkyl silicone polymer and mixtures thereof, preferably selected from the group consisting of tetra functionalized pentaerythritol tetrakis (3-mercaptobutylate), pentaerythritol tetra-3-mercaptopropionate, tris[2-(3-mercaptopropionyloxy) ethyl]isocyanurate and mixtures thereof.

Commercially available polythiol ligand for use in the present invention are for example KarenzMT™ PE1 from Showa Denko, GP-7200 from Genesee Polymers Corporation, PEMP from SC ORGANIC CHEMICAL CO. and THIOCURE® TEMPIC from BRUNO BOCK.

Preferably, individual nanocrystals forming the clustered nanocrystal network according to the present invention have a particle diameter (e.g. largest particle diameter) ranging from 1 nm to 100 nm, preferably from 1 nm to 50 nm and more preferably from 1 nm to 10 nm.

Preferably, the clustered nanocrystal networks according to the present invention have a particle diameter ranging from 1 μm to 100 μm, preferably from 2 μm to 20 μm.

NCs according to the present invention may comprise organic material and inorganic material in ratio between 2:1 and 75:1. Preferably, NCs according to the present invention may comprise inorganic material from 1 to 99% by weight based on the total weight of the NC. Preferably, NCs according to the present invention may comprise organic material from 1 to 99% by weight based on the total weight of the NC.

### Nanocrystal Composites Comprising Clustered Nanocrystal Networks

A nanocrystal composite (NC-composite) according to the present invention comprises clustered nanocrystal networks according to the present invention and a polymer matrix, wherein said clustered nanocrystal networks are embedded into said polymer matrix.

In some embodiments nanocrystal composite (NC-composite) according to the present invention comprises clustered nanocrystal networks according to the present invention and an organic or inorganic oxide matrix, wherein said clustered nanocrystal networks are embedded into said organic or inorganic oxide matrix.

Suitable individual nanocrystals and their compositions have been discussed in detail above.

A nanocrystal composite according to the present invention comprises a polymer matrix which is formed from monomers and/or oligomers selected from the group consisting of acrylates, methacrylates, polyester acrylates, polyurethane acrylates, acrylamides, methacrylamides, maleimides, bismaleimides, alkene containing monomers and/or oligomers, alkyne containing monomers and/or oligomers, vinylether containing monomers and/or oligomers, epoxy containing monomers and/or oligomers, oxetane containing monomers and/or oligomers, aziridine containing monomers and/or oligomers, isocyanates, isothiocyanates and mixtures thereof, preferably said polymer matrix is formed from monomers and/or oligomers selected from the group consisting of acrylates, polyester acrylates, polyurethane acrylates and epoxy containing monomers and/or oligomers and mixtures thereof.

Commercially available monomers and/or oligomers to be used in the present invention are for example SR238 and CN117 from Sartomer, Epikote 828 from Hexion, OXTP from UBE and PLY1-7500 from NuSil.

A NC-composite according to the present invention comprises clustered nanocrystal networks from 0.1 to 99.9% by weight of the composite, preferably from 10 to 50%, and more preferably from 20 to 40%.

A NC-composite according to the present invention comprises polymer matrix from 0.1 to 99.9 by weight of the composite, preferably from 50 to 90%, and more preferably from 60 to 80%.

A NC-composite according to the present invention has clustered nanocrystal networks embedded into the polymer matrix. FIG. 2 illustrates the structure of the NC-composite according to the present invention.

The present invention focuses also on the preparation of the clustered nanocrystal networks in a one-pot synthesis using polythiol ligand reagents. This polythiol ligand reagent acts as precursor, solvent, ligand stabilizer and crosslinker. Suitable polythiol ligand reagents to be used in the present invention have been described above in detail.

The clustered nanocrystal networks according to the present invention can be prepared in several ways of mixing all ingredients together.

In one preferred embodiment the preparation of the clustered nanocrystal networks according to the present invention comprises following steps:
1) mixing at least one metal or one semiconductive compound or a mixture thereof and at least one polythiol ligand to form a nanocrystal; and
2) precipitating said clustered nanocrystal network from acetone and/or elevated temperature.

The clustered nanocrystal network according to the present invention comprises a network of crosslinked nanocrystals, wherein said network of crosslinked nanocrystals is formed from nanocrystals comprising a core and at least one polythiol ligand. Polythiol ligand is used in excess as a solvent during the synthesis. After the synthesis, a colloidal solution is formed consisting of nanocrystals surrounded by polythiol ligands dissolved in an excess of the same polythiol ligand solution. During this process, the polythiol ligands can react with each other forming a network that comprises the nanocrystals surrounded by polythiol ligands crosslinked to another polythiol ligands and the excess of polythiols. In other words, each core is surrounded by at least one polythiol ligand, and in the network of crosslinked nanocrystals each core surrounded by at least one polythiol ligand is crosslinked with at least one another polythiol ligand surrounding another core. Preferably said network of crosslinked nanocrystals is formed via covalent bonds.

The present invention also focuses on the preparation of nanocrystal (NC) composites using clustered nanocrystal networks, which are embedded into said polymer matrix. In this way, well-dispersed, homogeneous and stable NC-composites can be easily prepared and afterward used in a wide range of applications. In addition the present invention allows the use of very high NC loadings e.g. 50 wt. % embedded into polymer matrix.

The nanocrystal composites according to the present invention can be prepared in several ways of mixing all ingredients together.

In one embodiment the preparation of the nanocrystal composites according to the present invention comprises following steps:
1) preparing clustered nanocrystal networks according to the present invention;
2) adding monomers and/or oligomers and/or polymer solution to form the polymer matrix and mixing;
3) curing with UV light and/or electron beam and/or temperature.

The preparation process according to the present invention does not involve any additional solvent and preferably does not involve the use of heavy metals.

The NC-composites according to the present invention can be used in a broad range of application by just changing the chemical composition of the nanocrystals.

For example clustered nanocrystal network of CuInS is suitable for display applications; PbS is suitable for solar cells; CuZnSnS is suitable for solar cells; CuFeSbS is suitable for thermoelectric applications; and FeSeS is suitable for magnetic applications.

The present invention also encompasses a product comprising a nanocrystal composite according to the present invention, the product can be selected from the group consisting of a display device, a light emitting device, a photovoltaic cell, a photodetector, an energy converter device, a laser, a sensor, a thermoelectric device, a security ink and in catalytic or biomedical applications. In preferred embodiments products are selected from the group consisting of display, lighting and solar cells.

The present invention also relates to use of nanocrystal composite according to the present invention as a source of photoluminescence or electroluminescence.

### EXAMPLES

### Example 1

### CuInSeS/ZnS/ZnS-Tris[2-(3-mercaptopropionyloxy)ethyl]iso-cyanurate (CuInSeS/ZnS/ZnS-TEMPIC) Clustered NC Network in a Silicone Matrix

0.2 g (i.e. 10 wt. %) NC bulk powder (CuInSeS/ZnS/ZnS:TEMPIC) is mixed in 1.8 g (i.e. 90 wt. %) of a two-part optical silicone (i.e. NuSil Lightspan 6140). The resulting formulation is mixed in a conditioning mixer for 2 minutes at 3000 rpm. Subsequently, the mixture is dispensed using a 1 ml plastic pipette into an aluminum cup and cured thermally at 150° C. during 15 minutes. An orange emitting semiconductor NC-composite is obtained.

### Clustered NC Network Synthesis:

0.08 g of CuI, 0.4 g of In(OAc)3 and 0.16 ml stock solution DPPSe are dissolved in 10 ml TEMPIC. The mixture is heated at 190° C. for 10 minutes. A mixture of 0.6 g of Zn(OAc)₂.2H₂O in 5 ml TEMPIC is added to the core solution and the mixture is heated at 230° C. for 60 minutes. Then a mixture of 0.6 g of ZnSt₂ in 5 ml TEMPIC is added to the core/shell solution and heated at 230° C. for 30 minutes. An orange colloidal semiconductor NC solution (CuInSeS/ZnS/ZnS-TEMPIC) is obtained. Subsequently, 10 ml of the obtained colloidal semiconductor NC solution is quenched at 200° C. with an excess of acetone. The mixture is allowed to settle down at RT and subsequently dried in an oven at 120° C. for 3 hours. The obtained solids are mechanical grinded till a fine powder is obtained. An orange NC bulk powder is obtained with a confirmed quantum yield of 36%.

### Example 2

### CuInSeS-Pentaerythritol Tetra-3-mercaptopropionate (CuInSeS-PEMP) Clustered NC Network

### Clustered NC Network Synthesis:

0.5 g of CuI, 2.5 g of In(OAc)3 and 1 ml stock solution DPPSe are dissolved in 10 g of PEMP. The mixture is heated at 210° C. for 10 minutes. A red semiconductor colloidal NC solution (CuInSeS-PEMP) is obtained. Subsequently, 5 ml of the obtained solution is quenched at 200° C. with an excess of acetone. The mixture is allowed to settle down at RT and subsequently dried in an oven at 120° C. for 3 hours. The obtained solids are mechanical grinded till a fine powder is obtained.

### Example 3

### CuInSeS-Trimethylolpropane Tri(3-mercaptopropionate) (CuInSeS-TMMP) Clustered NC Network

### Clustered NC Network Synthesis:

0.1 g of CuI, 0.5 g of In(OAc)₃ and 0.2 ml stock solution DPPSe are dissolved in 10 g of TMMP. The mixture is heated at 170° C. for 5 minutes. A red semiconductor colloidal NC solution (CuInSeS-TMMP) is obtained. Subsequently, 5 ml of the obtained solution is quenched at 200° C. with an excess of acetone. The mixture is allowed to settle down at RT and subsequently dried in an oven at 120° C. for 3 hours. The obtained solids are mechanical grinded till a fine powder is obtained.

### Example 4

### Cu:ZnInS-Tris[2-(3-mercaptopropionyloxy)ethyl]iso-cyanurate (Cu:ZnInS-TEMPIC) Clustered NC Network

### Clustered NC Network Synthesis:

0.015 g of CuI, 0.2 g of In(OAc)₃ and 0.3 g of Zn(OAc)₃ are dissolved in 10 ml of TEMPIC. The mixture is heated at 220° C. for 20 minutes. A yellow semiconductor colloidal NC solution (Cu:ZnInS-TEMPIC) is obtained. Subsequently, 5 ml of the obtained solution is quenched at 200° C. with an excess of acetone. The mixture is allowed to settle down at RT and subsequently dried in an oven at 120° C. for 3 hours. The obtained solids are mechanical grinded till a fine powder is obtained.

### Example 5

### Cu:ZnInS-Tris[2-(3-mercaptopropionyloxy)ethyl]iso-cyanurate (Cu:ZnInS-TEMPIC) Clustered NC Network

### Clustered NC Network Synthesis:

0.015 g of CuI, 0.2 g of In(OAc)₃ and 0.3 g of Zn(OAc)₃ are dissolved in 10 ml of TEMPIC. The mixture is heated at 220° C. for 20 minutes. A yellow semiconductor colloidal NC solution (Cu:ZnInS-TEMPIC) is obtained. Subsequently, 1 ml of the obtained solution is added to an aluminium cup and heated overnight at 200° C. A yellow emitting solid is obtained.

### Example 6

### CuInS/ZnS/ZnS-Pentaerythritol tetrakis (3-mercaptobutylate) (CuInS/ZnS/ZnS-KarenzMT™ PE1) Clustered NC Network

### Clustered NC Network Synthesis:

0.24 g of CuI and 1.46 g of In(OAc)₃ are dissolved in 50 ml KarenzMT™ PE1. The mixture is heated at 210° C. for 10 minutes. A mixture of 1.7 g of Zn(OAc)₂.2H₂O in 25 ml KarenzMT™ PE1 is added to the core solution and the mixture is heated at 230° C. for 45 minutes. Then a mixture of 1.7 g of ZnSt₂ in 25 ml KarenzMT™ PE1 is added to the core/shell solution and heated at 230° C. for 45 minutes. A red semiconductor colloidal NC solution (CuInSeS/ZnS/ZnS-KarenzMT™ PE1) is obtained. Subsequently, 1 ml of the obtained colloidal semiconductor NC solution is added to an aluminium cup and heated overnight at 200° C. A red emitting solid is obtained.

What is claimed is:

1. A clustered nanocrystal network comprising a plurality of nanocrystals comprising
a) a core comprising a metal or a semiconductive compound or a mixture thereof; and
b) at least one polythiol ligand,
wherein said core is surrounded by at least one polythiol ligand, and wherein each core surrounded by at least one polythiol ligand is crosslinked with at least one another polythiol ligand surrounding another core.

2. A clustered nanocrystal network according to claim 1, wherein said core comprising a metal or a semiconductive compound or a mixture thereof is composed of elements selected from one or more different groups of the periodic table

3. A clustered nanocrystal network according to claim 1, wherein said core comprises a core and at least one monolayer or multilayer shell or wherein said core comprises a core and at least two monolayer and/or multilayer shells.

4. A clustered nanocrystal network according to claim 1, wherein said metal or semiconductive compound is combination of one or more elements selected from the group IV; one or more elements selected from the groups II and VI; one or more elements selected from the groups III and V; one or more elements selected from the groups IV and VI; and one or more elements selected from the groups I and III and VI; or a combination thereof.

5. A clustered nanocrystal network according to claim 1, wherein said core comprising metal or semiconductive compound or mixture thereof is selected from the group consisting of CuInS, CuInSeS, CuZnInSeS, CuZnInS, Cu:ZnInS, CuInS/ZnS, Cu:ZnInS/ZnS and CuInSeS/ZnS.

6. A clustered nanocrystal network according to claim 1, wherein said at least one polythiol ligand has functionality at least 2.

7. A clustered nanocrystal network according to claim 1, wherein said at least one polythiol ligand is selected from the group consisting of primary polythiols and secondary polythiols and mixtures thereof, preferably at least one polythiol ligand is selected from the group consisting of pentaerythritol tetrakis (3-mercaptobutylate), pentaerythritol tetra-3-mercaptopropionate, trimethylolpropane tri(3-mercaptopropionate), tris[2-(3-mercaptopropionyloxy)ethyl]isocyanurate, dipentaerythritol hexakis(3-mercaptopropionate), ethoxilated-trimethylolpropan tri-3-mercaptopropionate, mercapto functional methylalkyl silicone polymer and mixtures thereof.

8. A process to prepare a clustered nanocrystal network according to claim 1 comprising steps of:
a) mixing at least one metal or semiconductive compound or mixture thereof and at least one polythiol ligand to form a nanocrystal, and
b) precipitating said clustered nanocrystal network from acetone and/or elevated temperature.

9. A nanocrystal composite comprising
a) clustered nanocrystal network according to claim 1; and
b) a polymer matrix,
wherein said clustered nanocrystal networks are embedded into said polymer matrix.

10. A nanocrystal composite according to claim 9 wherein said polymer matrix is formed from monomers and/or oligomers selected from the group consisting of acrylates, methacrylates, polyester acrylates, polyurethane acrylates, acrylamides, methacrylamides, maleimides, bismaleimides, alkene containing monomers and/or oligomers, alkyne containing monomers and/or oligomers, vinylether containing monomers and/or oligomers, epoxy containing monomers and/or oligomers, oxetane containing monomers and/or oligomers, aziridine containing monomers and/or oligomers, isocyanates, isothiocyanates and mixtures thereof, preferably said polymer matrix is formed from monomers and/or oligomers selected from the group consisting of acrylates, polyester acrylates, polyurethane acrylates and epoxy containing monomers and/or oligomers and mixtures thereof.

11. A nanocrystal composite according to claim 9 comprising clustered nanocrystal networks from 0.1 to 99.9% by weight of the composite.

12. A nanocrystal composite according to claim 9 comprising polymer matrix from 0.1 to 99.9 by weight of the composite.

13. A process to prepare a nanocrystal composite according to claim 9 comprising steps of:
a) adding clustered nanocrystal network comprising a plurality of nanocrystals comprising
i) a core comprising a metal or a semiconductive compound or a mixture thereof; and
ii) at least one polythiol ligand,
wherein said core is surrounded by at least one polythiol ligand, and wherein each core surrounded by at least one polythiol ligand is crosslinked with at least one another polythiol ligand surrounding another core;
b) adding monomers and/or oligomers to form the polymer matrix and mixing;
c) curing with UV light and/or temperature and/or electron beam.

14. A product comprising a nanocrystal composite according to claim 9, wherein said product is selected from the group consisting of a display device, a light emitting device, a photovoltaic cell, a photodetector, an energy converter device, a laser, a sensor, a thermoelectric device, a security ink and in catalytic or biomedical applications.

15. Use of nanocrystal composite according to claim 9 as a source of photoluminescence or electroluminescence.
